(19) United States
(12) Patent Application Publication
(10) Pub. No.: US 2026/0317938 A1
(43) Pub. Date: Oct. 15, 2026

(54) REVERSIBLE METAL DEPOSITION DEVICE

(71) Applicant: The Boeing Company, Arlington, VA (US)

(72) Inventors: Adam Franklin Gross, Santa Monica, CA (US); John James Vajo, Westhills, CA (US); Jason Samuel Lipton, Los Angeles, CA (US); Shirell Eliezra Klein, Agoura Hills, CA (US); Xiaoxi Wang, Mukilteo, WA (US); Mark Steven Palmquist, Wildwood, MO (US)

(21) Appl. No.: 19/179,408

(22) Filed: Apr. 15, 2025

(51) Int. Cl. C25D 5/48; C25D 3/38; C25D 3/46

(52) U.S. Cl. CPC C25D 5/48; C25D 3/38; C25D 3/46

(57) ABSTRACT

Reversible metal deposition devices are presented. A reversible metal deposition device comprises a transparent conductive electrode, a counter electrode, an electrolyte between the transparent conductive electrode and the counter electrode, a stripping additive in the electrolyte, and metal salt in the electrolyte that supplies metal to be reversibly deposited onto the transparent conductive electrode. The electrolyte contains less than 5 atomic percent water. The stripping additive comprises at least one of an acid or a base.

### BACKGROUND INFORMATION

### 1. Field

The present disclosure relates generally to reversible metal deposition devices.

### 2. Background

It may be desirable to have electrically dimming windows in transportation vehicles such as aircraft. Many technologies exist for electrically dimming windows. In liquid crystal windows, power is applied continuously in the light-transmitting state. Charged particle devices like e-ink have a haze or distortion of the image through the window. Traditional electrically darkening windows absorb light in the dark state. Absorption of heat results in the windows heating up and radiating heat into the passenger compartment when exposed to sunlight. Radiating heat into the cabin can cause additional fuel use and discomfort in the vehicle.

Therefore, it would be desirable to have a method and apparatus that takes into account at least some of the issues discussed above, as well as other possible issues.

### SUMMARY

An embodiment of the present disclosure provides a reversible metal deposition device. The reversible metal deposition device comprises a transparent conductive electrode, a counter electrode, an electrolyte between the transparent conductive electrode and the counter electrode, a stripping additive in the electrolyte, and metal salt in the electrolyte that supplies metal to be reversibly deposited onto the transparent conductive electrode. The electrolyte contains less than 5 atomic percent water. The stripping additive comprises at least one of an acid or a base.

An embodiment of the present disclosure provides a reversible metal deposition device. The reversible metal deposition device comprises a transparent conductive electrode comprising one of a glass sheet or a polymer sheet, a counter electrode, an electrolyte between the transparent conductive electrode and the counter electrode, a stripping additive in the electrolyte, metal salt in the electrolyte that supplies metal to be reversibly deposited onto the transparent conductive electrode, and a second substrate comprising a second glass sheet or a second polymer sheet. The electrolyte contains less than 5 atomic percent water. The stripping additive comprises an acid.

An embodiment of the present disclosure provides a reversible metal deposition device. The reversible metal deposition device comprises a transparent conductive electrode, a counter electrode, an electrolyte in contact with the transparent conductive electrode, metal salt in the electrolyte that supplies metal to be reversibly deposited onto the transparent conductive electrode, and a stripping additive in the electrolyte. The stripping additive comprises at least one of an acid or a base configured to stop passivation of a metal layer formed on the transparent conductive electrode when the metal is deposited on the transparent conductive electrode. The electrolyte contains less than 5 atomic percent water. The metal salt comprises one of copper or silver.

The features and functions can be achieved independently in various embodiments of the present disclosure or may be combined in yet other embodiments in which further details can be seen with reference to the following description and drawings.

### BRIEF DESCRIPTION OF THE DRAWINGS

The novel features believed characteristic of the illustrative embodiments are set forth in the appended claims. The illustrative embodiments, however, as well as a preferred mode of use, further objectives and features thereof, will best be understood by reference to the following detailed description of an illustrative embodiment of the present disclosure when read in conjunction with the accompanying drawings, wherein:

FIG. 1 is an illustration of an aircraft in accordance with an illustrative embodiment;

FIGS. 2A and 2B is an illustration of a block diagram of a manufacturing environment in accordance with an illustrative embodiment;

FIG. 3 is an illustration of a cross-sectional view of a reversible metal deposition device in accordance with an illustrative embodiment;

FIG. 4 is an illustration of a cross-sectional view of a reversible metal deposition device in accordance with an illustrative embodiment;

FIG. 5 is an illustration of a graph of dynamic optical transmittance measurements over time without a stripping additive;

FIG. 6 is an illustration of a graph of dynamic optical transmittance measurements over time in accordance with an illustrative embodiment;

FIG. 7 is an illustration of an aircraft manufacturing and service method in a form of a block diagram in accordance with an illustrative embodiment; and

FIG. 8 is an illustration of an aircraft in a form of a block diagram in which an illustrative embodiment may be implemented.

### DETAILED DESCRIPTION

The illustrative examples recognize and take into account several considerations. The illustrative examples recognize and take into account that traditional electrochromics absorb light in the dark state. The illustrative examples recognize and take into account that absorbing light results in the electrochromics heating up and radiating heat into the passenger compartment when exposed to sunlight. The illustrative examples recognize and take into account that this heat requires more cooling and thus energy to be used, which comes from the vehicle’s fuel.

The illustrative examples recognize and take into account that metal deposition devices deposit a layer of metal on a transparent conductive electrode. They create a mirror-like surface that reflects light instead of absorbing it. The illustrative examples recognize and take into account that conventional metal deposition devices use an aqueous electrolyte that supports the dissolution of metal ions. The illustrative examples recognize and take into account that an aqueous electrolyte helps the metal layer dissolve when directed to change to a transparent state. The illustrative examples recognize and take into account that a water-based electrolyte creates unwanted vapor pressure at high temperatures that will break open the device. The illustrative examples recognize and take into account that during operation, aerospace windows are exposed to high and low temperatures. The illustrative examples recognize and take into account that aerospace windows are desirably designed to endure both high and low temperatures. The illustrative examples recognize and take into account that some non-aqueous electrolyte based devices use a chemical couple (cycles between two oxidation states) on the anode for dissolving away the plated metal. The illustrative examples recognize and take into account that for non-aqueous electrolyte based devices using a chemical couple on the anode, a power off hold is not possible.

The illustrative examples present a reversible metal deposition device with stripping enhancing non-aqueous electrolyte. The illustrative examples present an electrochemical device that reversibly plates metal on an internal surface to control the reflection of light off that surface. The reversible metal deposition device has a non-aqueous electrolyte, which enables the metal deposition devices to operate in a wider temperature range than aqueous electrolytes. Non-aqueous electrolytes can have decreased vapor pressures in comparison to aqueous electrolytes. The illustrative examples present a stripping additive in the non-aqueous electrolyte. Plated metal films are more stable in a non-aqueous electrolyte than in an aqueous electrolyte. Stripping of the metal films can be slowed or halted in the non-aqueous electrolyte. Adding a stripping additive of at least one of an acid or a base creates stripping conditions that promote the stripping of metal off the electrode. The stripping additive allows the reversible metal deposition device to cycle.

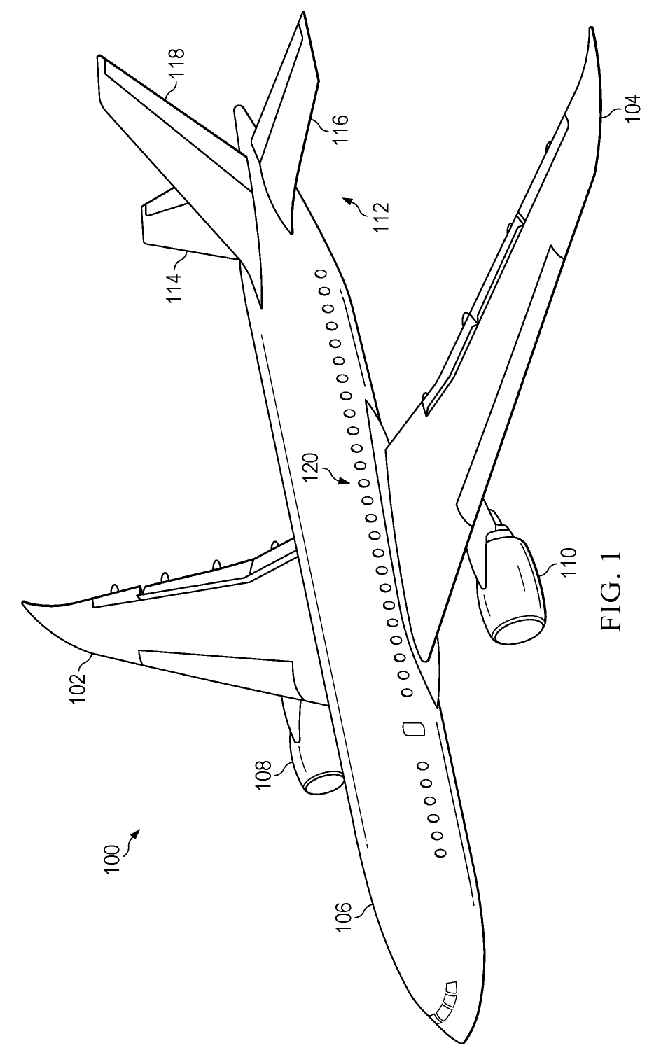

Turning now to FIG. 1, an illustration of an aircraft is depicted in accordance with an illustrative embodiment. Aircraft 100 has wing 102 and wing 104 attached to body 106. Aircraft 100 includes engine 108 attached to wing 102 and engine 110 attached to wing 104.

Body 106 has tail section 112. Horizontal stabilizer 114 , horizontal stabilizer 116, and vertical stabilizer 118 are attached to tail section 112 of body 106.

Plurality of windows 120 is present in body 106. Plurality of windows 120 allows passengers in body of aircraft 100 to view outside of aircraft 100.

Aircraft 100 is an example of an aircraft that can have reversible metal deposition devices. In this illustrative example, plurality of windows 120 can be formed of a plurality of reversible metal deposition devices.

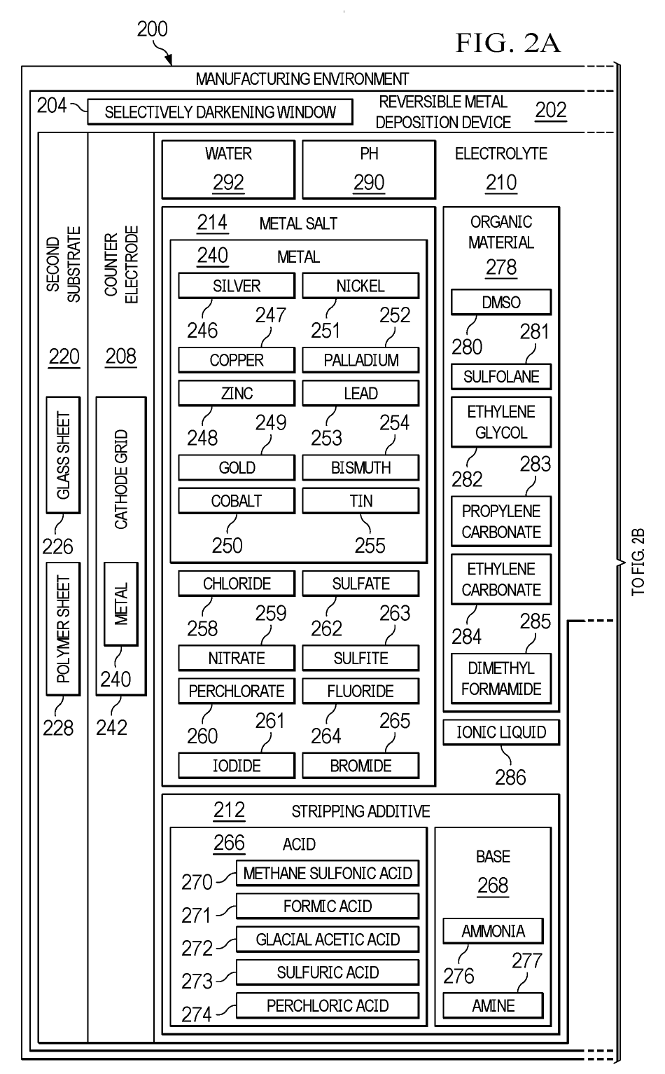

Turning now to FIGS. 2A and 2B, an illustration of a block diagram of a manufacturing environment is depicted in accordance with an illustrative embodiment. Reversible metal deposition device 202 can be formed in manufacturing environment 200. Reversible metal deposition device 202 can be used as a window of plurality of windows 120 of aircraft 100 of FIG. 1.

Reversible metal deposition device 202 comprises a non-aqueous electrolyte, electrolyte 210. Electrolyte 210 provides a temperature stability to reversible metal deposition device 202.

Stripping additive 212 is added to electrolyte 210 to enable repeated dissolving of metal layer 216. Stripping additive 212 is added to electrolyte 210 so that stripping additive 212 breaks down passivation 244 layer of metal layer 216 upon application of an electric potential. Reversible metal deposition device 202 has a power off hold.

Passivation 244 would stop metal 240 from dissolving into electrolyte 210 and stop reversible metal deposition device 202 from cycling. By including stripping additive 212 in electrolyte 210, pH 290 of electrolyte 210 is modified. By modifying pH 290 of electrolyte 210, ions of metal 240 become stable, such that metal layer 216 can dissolve into electrolyte 210.

Reversible metal deposition device 202 comprises transparent conductive electrode 206, counter electrode 208, electrolyte 210 between transparent conductive electrode 206 and counter electrode 208, stripping additive 212 in electrolyte 210, and metal salt 214 in electrolyte 210 that supplies metal 240 to be reversibly deposited onto transparent conductive electrode 206. Electrolyte 210 contains less than 5 atomic percent water 292. Stripping additive 212 comprises at least one of acid 266 or base 268. The at least one of acid 266 or base 268 is not an aqueous solution.

Metal salt 214 in electrolyte 210 can be used to reversibly deposit metal 240 on to transparent conductive electrode 206. In some illustrative examples, metal salt 214 comprises one of silver 246, copper 247, zinc 248, gold 249, cobalt 250, nickel 251, palladium 252, lead 253, bismuth 254, or tin 255. In some illustrative examples, metal salt 214 comprises one of aluminum, iron, gallium, indium, platinum, or tungsten. In some illustrative examples, metal salt 214 comprises one of silver 246, copper 247, zinc 248, gold 249, cobalt 250, nickel 251, palladium 252, lead 253, bismuth 254, tin 255, aluminum, iron, gallium, indium, platinum, or tungsten.

Metal 240 can take the form of any desirable metal. In some illustrative examples, metal 240 can be selected based on at least one of percent light reflection or percent light absorption. Metal 240 is desirably more highly reflective and less absorbative. In some illustrative examples, metal 240 is selected based on electrochemical potential. Selection of metal 240 based on electrochemical potential can utilize lower levels of power for plating and stripping. In some illustrative examples, metal salt 214 comprises one of copper 247 or silver 246.

In some illustrative examples, metal salt 214 comprises one of chloride 258, nitrate 259, perchlorate 260, sulfate 262, sulfite 263, fluoride 264, iodide 261, or bromide 265. In some illustrative examples, metal salt 214 takes the form of perchlorate 260.

Electrolyte 210 can take any desirable form. In some illustrative examples, electrolyte 210 comprises organic material 278 selected from one of DMSO 280, sulfolane 281, ethylene glycol 282, propylene carbonate 283, ethylene carbonate 284, or dimethyl formamide 285. In some illustrative examples, electrolyte 210 comprises organic material 278 as a solvent. In some illustrative examples, electrolyte 210 further comprises a dissolved salt in addition to organic material 278. In some illustrative examples, electrolyte 210 further comprises lithium chloride as a dissolved salt in addition to organic material 278. In some illustrative examples, electrolyte 210 comprises at least one of DMSO 280 or propylene carbonate 283. In some illustrative examples, electrolyte 210 comprises ionic liquid 286. In some illustrative examples, electrolyte 210 comprises at least one of imidazolium, ammonium, pyrrolidinium, sulfonium, phosphonium, pyrazolidium, piperidinium, pyridinium, TFSI, hexafluorophosphate, bisnonafluoro-1-butanesulfonimidate, perchlorate, chloride, thiocyanate, DFOB, nitrate, tetra fluoroborate, or triflate. In some illustrative examples, electrolyte 210 comprises at least one cation and at least one anion.

Electrolyte 210 can be referred to as a non-aqueous electrolyte. In some illustrative examples, electrolyte 210 comprises less than 4 atomic percent water 292. In some illustrative examples, electrolyte 210 comprises less than 3 atomic percent water 292. In some illustrative examples, electrolyte 210 comprises less than 2 atomic percent water 292. In some illustrative examples, electrolyte 210 comprises less than 1 atomic percent water 292. In some illustrative examples, electrolyte 210 comprises less than 0.5 atomic percent water 292. In some illustrative examples, electrolyte 210 comprises less than 100 parts per million water 292.

Stripping additive 212 is selected based on type of metal 240. In some illustrative examples, stripping additive 212 comprises at least one of methane sulfonic acid 270, formic acid 271, glacial acetic acid 272, sulfuric acid 273, or perchloric acid 274. In some illustrative examples, stripping additive 212 comprises at least one of ammonia 276 or amine 277.

In some illustrative examples, transparent conductive electrode 206 comprises one of indium tin oxide electrode 230 or a fluorine-doped tin oxide electrode 232 on substrate 218, wherein substrate 218 is a glass sheet 222 or a polymer sheet 224. In some illustrative examples, transparent conductive electrode 206 comprises metal grid 234 on substrate 218, wherein substrate 218 is glass sheet 222 or polymer sheet 224. In some illustrative examples, transparent conductive electrode 206 comprises at least one of graphene 238 or carbon nanotubes 236 on substrate 218, wherein the substrate 218 is glass sheet 222 or polymer sheet 224.

In some illustrative examples, reversible metal deposition device 202 further comprises wetting layer 288 on transparent conductive electrode 206. In some illustrative examples, wetting layer 288 is a metal comprising at least one of platinum, gold, iridium, or palladium. In some illustrative examples, wetting layer 288 is non-metallic. In some illustrative examples, wetting layer 288 is made by treating transparent conductive electrode 206 with ozone, UV, plasma, or a corona treatment. In some illustrative examples, wetting layer 288 is an oxide. In some illustrative examples, wetting layer 288 is made by treating transparent conductive electrode 206 with at least one of flame treatment, chemical etching, vapor degreasing, or laser ablation. In some illustrative examples, wetting layer 288 is a surfactant or self-assembled monolayer.

In some illustrative examples, counter electrode 208 comprises cathode grid 242. In some illustrative examples, counter electrode 208 takes the form of a transparent conductive electrode.

In some illustrative examples, reversible metal deposition device 202 is selectively darkening window 204. In some illustrative examples, selectively darkening window 204 further comprises reflective material 294 on outer surface 296 of selectively darkening window 204. In some illustrative examples, reflective material 294 can be at least one of broadband reflective, UV reflective, or near infrared reflective.

In some illustrative examples, reversible metal deposition device 202 takes the form of selectively darkening window 204. Selectively darkening window 204 comprises substrate 218 and second substrate 220. In some illustrative examples, second substrate 220 comprises either glass sheet 226 or polymer sheet 228. Second substrate 220 contains electrolyte 210 in reversible metal deposition device 202.

The illustration of manufacturing environment 200 in FIG. 2 is not meant to imply physical or architectural limitations to the manner in which an illustrative embodiment may be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment.

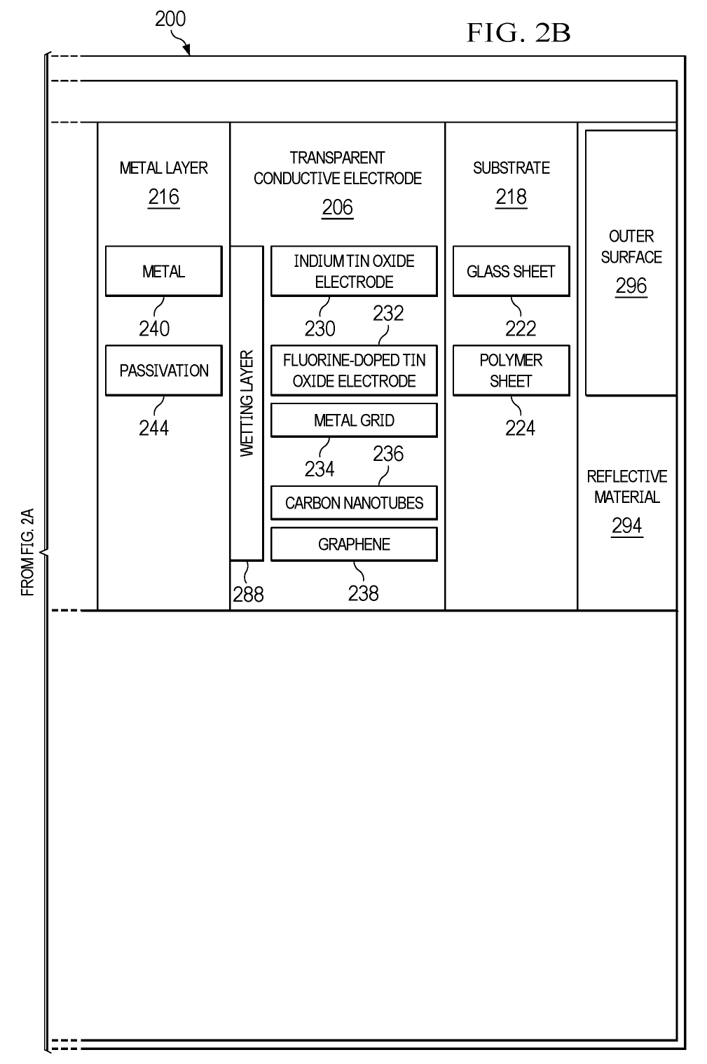

Turning now to FIG. 3 , an illustration of a cross-sectional view of a reversible metal deposition device is depicted in accordance with an illustrative embodiment. Reversible metal deposition device 300 can be used in a window of plurality of windows 120 of aircraft 100 in FIG. 1. Reversible metal deposition device 300 can be a physical implementation of reversible metal deposition device 202 of FIG. 2.

Reversible metal deposition device 300 comprises transparent conductive electrode 308, counter electrode 302, electrolyte 304 between transparent conductive electrode 308 and counter electrode 302, stripping additive (not depicted) in electrolyte 304, and metal salt in electrolyte 304 that supplies metal to be reversibly deposited onto transparent conductive electrode 308. As depicted, the metal is present in metal layer 306 against transparent conductive electrode 308. In this illustrative example, metal layer 306 comprises plated metal for light rejection. Transparent conductive electrode 308 can be referred to as a wetting electrode. In this illustrative example, metal layer 306 against transparent conductive electrode 308 presents a dark state.

In this illustrative example, electrolyte 304 contains less than 5 atomic percent water. Electrolyte 304 can also be referred to as a deposition mediating non-aqueous electrolyte. In this illustrative example, the stripping additive comprises at least one of an acid or a base.

As depicted, counter electrode 302 takes the form of a cathode grid formed of a same metal as the metal in metal layer 306. By the cathode grid being formed of the same metal as metal layer 306, operation of reversible metal deposition device 300 can be done with a lower power.

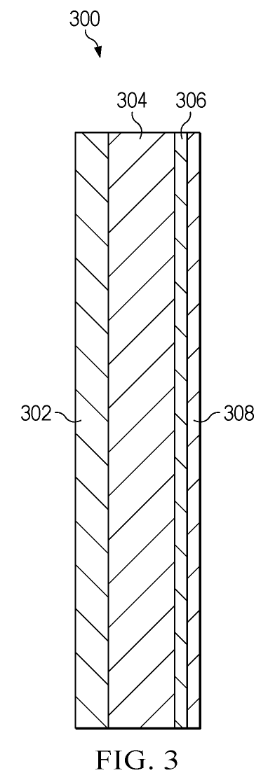

Turning now to FIG. 4, an illustration of a cross-sectional view of a reversible metal deposition device is depicted in accordance with an illustrative embodiment. Reversible metal deposition device 400 can be used in a window of plurality of windows 120 of aircraft 100 in FIG. 1. Reversible metal deposition device 400 can be a physical implementation of reversible metal deposition device 202 of FIG. 2.

In this illustrative example, reversible metal deposition device 400 takes the form of selectively darkening window 401. Selectively darkening window 401 comprises substrate 404 and second substrate 402. Each of substrate 404 and second substrate 402 comprises either a glass sheet or a polymer sheet. In this illustrative example, reflective material 406 is present on substrate 404. Reflective material 406 is optional. Reflective material 406 can reflect sunlight to reduce the amount of sunlight entering selectively darkening window 401.

Reversible metal deposition device 400 comprises transparent conductive electrode 408, counter electrode 410, electrolyte 412 between transparent conductive electrode 408 and counter electrode 410, stripping additive (not depicted) in electrolyte 412, and metal salt in electrolyte 412 that supplies metal to be reversibly deposited onto transparent conductive electrode 408. As depicted, the metal is present in metal layer 414 against transparent conductive electrode 408. In this illustrative example, metal layer 414 comprises plated metal for light rejection. Transparent conductive electrode 408 can be referred to as a wetting electrode. In this illustrative example, metal layer 414 against transparent conductive electrode 408 presents a dark state.

In this illustrative example, electrolyte 412 contains less than 5 atomic percent water. Electrolyte 412 can also be referred to as a deposition mediating non-aqueous electrolyte. In this illustrative example, the stripping additive comprises at least one of an acid or a base.

As depicted, counter electrode 410 takes the form of a cathode grid formed of a same metal as the metal in metal layer 414. By the cathode grid being formed of the same metal as metal layer 414, operation of reversible metal deposition device 400 can be done with a lower power. In some illustrative examples, counter electrode 410 takes the form of a grid with a core formed of an inert metal plated with a coating of the same metal as the metal in metal layer 414.

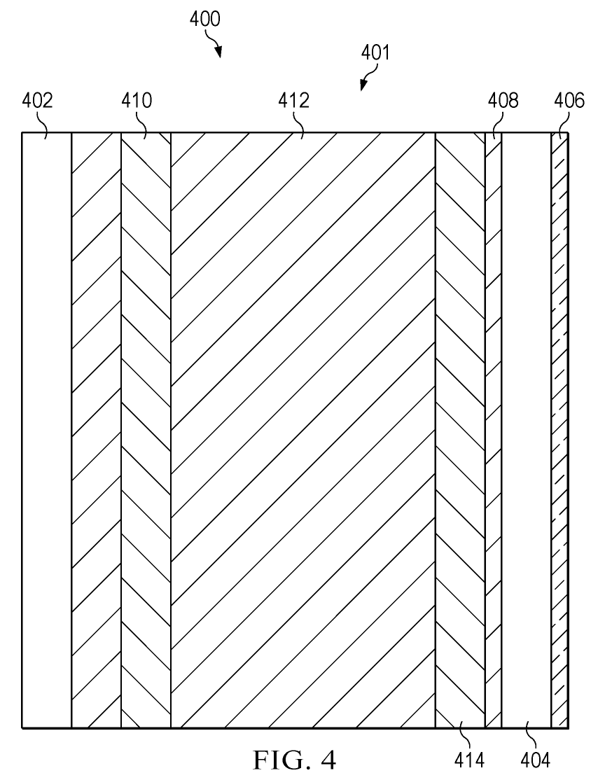

Turning now to FIG. 5, an illustration of a graph of dynamic optical transmittance measurements over time without a stripping additive is depicted. Graph 500 presents data for a reversible metal deposition device without a stripping additive. More specifically, graph 500 presents dynamic optical transmittance measurements during reversible electroplating and dissolution of Cu onto ITO in an ethylene glycol-based electrolyte with no introduced acid or base. Transmittance is reduced as a copper film forms and recovers as it is dissolved.

Graph 500 has y-axis 502 of transmittance in percentage and x-axis 504 of time in seconds. Three different stages of operation, deposition 506, rest 508, and dissolution 510 are depicted in graph 500. During deposition 506, an applied voltage deposits the metal into a metal layer. During rest 508, the current state is maintained. During dissolution 510, a polarity of the applied voltage is reversed, to dissolve the copper. Data 511 presents measurements of transmittance for the reversible metal deposition device without a stripping additive.

At time zero, deposition 512 begins. After deposition, rest 514 maintains a metal layer to reduce transmittance. During the first dissolution, dissolution 516, the copper dissolves over about 100 seconds. After rest 518, the copper is deposited to form a metal layer in deposition 520. The system rests during rest 522. Following rest 522, dissolution 524 is substantially slower than dissolution 516.

An electrochromic without acid does not stably cycle. Slow stripping starting at approximately 600 seconds can be seen in dissolution 524. Following rest 526, the metal is redeposited during deposition 528. Following rest 530, dissolution 532 begins. No stripping is depicted after 1500 seconds. The slow stripping in dissolution 524 and failure to strip in dissolution 532 is due to the passivation of the metal layer.

Electrochemical deposition and dissolution of Cu in ethylene glycol (EG) -based electrolyte is shown in FIG. 5. The set-up consists of an electrochemical cell with a quartz window for probing transmission during illumination. Indium tin oxide (ITO) is used as the transparent working electrode (WE) with a Cu counter electrode in a 2-electrode format. The electrolyte consists of 0.1 M CuClO₄ as a Cu source and 1 M LiClO₄ as a supporting electrolyte dissolved in ethylene glycol. Upon applying a reducing voltage to the ethylene glycol, Cu is plated onto the indium tin oxide layer, resulting in reduced transmittance. After a brief rest, an oxidizing voltage is applied to the transparent working electrode to electrochemically dissolve the Cu metal layer, resulting in increased transmittance. However, after the first cycle, shown in deposition 512, rest 514, and dissolution 516, the oxidizing voltage is slower to dissolve the Cu metal. In the third cycle, shown in deposition 528, rest 530, and dissolution 532, it does not dissolve the metal layer, so transmission does not recover.

Failure to dissolve in dissolution 532 is due to the formation of a passivating layer on the surface of the copper. In the neutral pH range at oxidizing voltage, Cu forms Cu2O or Cu(OH)2. Neither species is soluble in EG, so a thin passivating surface is formed on the Cu deposit. The thin passivating surface prevents further dissolution.

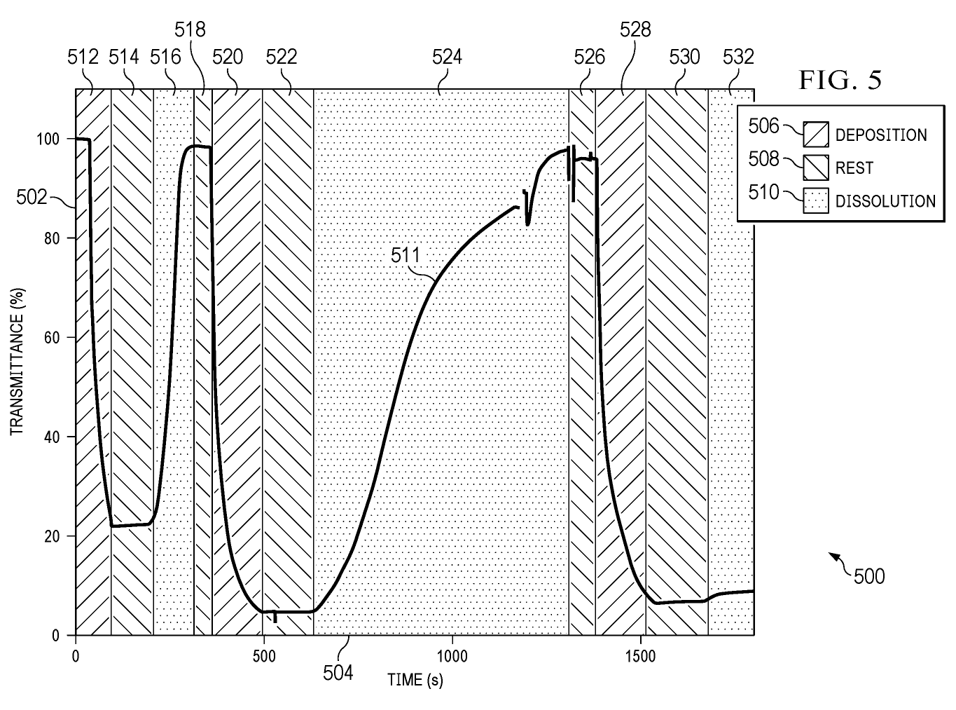

Turning now to FIG. 6, an illustration of a graph of dynamic optical transmittance measurements over time is depicted in accordance with an illustrative embodiment. Graph 600 can be a graph of dynamic optical transmittance measurements for a window of plurality of windows 120 in aircraft 100 of FIG. 1. Graph 600 can be a graph of dynamic optical transmittance measurements for reversible metal deposition device 202 of FIG. 2. Graph 600 can be a graph of dynamic optical transmittance measurements for reversible metal deposition device 300 of FIG. 3. Graph 600 can be a graph of dynamic optical transmittance measurements for reversible metal deposition device 400 of FIG. 4.

Graph 600 presents dynamic optical transmittance measurements during the first several cycles of reversible electroplating and dissolution of Cu onto ITO in an ethylene glycol-based electrolyte with an introduced acid as a stripping agent. Transmittance is reduced as copper film forms and recovers as it is dissolved. Using a stripping agent in the non-aqueous electrolyte enables successfully deposition and dissolving repeatedly with no apparent degradation. Adding acid to the electrochromic results in repeatable plating (darkening) and stripping (clearing or lightening).

Electrochemical deposition and dissolution of Cu in ethylene glycol (EG) -based electrolyte with added acid is shown in graph 600. The experimental setup is the same as in graph 500, the only difference being the addition of 10 mM methanesulfonic acid (MSA) to the electrolyte. With the addition of MSA, electrochemical dissolution is no longer inhibited by the passivation of the Cu film described in graph 500 of FIG. 5. The pH has been reduced to the point that Cu2 ⁺ is the dominant species under oxidizing voltage, which is soluble in EG. The dissolution rate appears stable over multiple cycles. A stable reversible electrochemical deposition and dissolution has been performed over >100 cycles (not depicted). Adding a pH modifier as a stripping agent prevents the passivation of the Cu metal layer in this reversible electrochromic mirror device.

Graph 600 has y-axis 602 of transmittance in percentage and x-axis 604 of time in seconds. Three different stages of operation, deposition 606, rest 608, and dissolution 610 are depicted in graph 600. During deposition 606, an applied voltage deposits the metal into a metal layer. During rest 608, the current state is maintained. During dissolution 610, a polarity of the applied voltage is reversed, to dissolve the copper. Data 611 presents measurements of transmittance for the reversible metal deposition device with a stripping additive.

In graph 600, four cycles of the reversible metal deposition device are depicted. Deposition 606 includes deposition 614, deposition 622, deposition 630, and deposition 638. Rests 608 are between deposition 606 and dissolution 610. Rests 608 include rest 612, rest 616, rest 620, rest 624, rest 628, rest 632, rest 636, rest 640, and rest 644.

Dissolution 610 includes dissolution 618, dissolution 626, dissolution 634, and dissolution 642. Although transmittance and time are not identical for each cycle, after each of dissolution 618, dissolution 626, dissolution 634, and dissolution 642, transmittance is approximately 100%. Additionally, although transmittance and time are not identical for each cycle, each of dissolution 618, dissolution 626, dissolution 634, and dissolution 642 is performed over less than two minutes. Further, although transmittance and time are not identical for each cycle, each of dissolution 618, dissolution 626, dissolution 634, and dissolution 642 is performed in the range of approximately 50 seconds to approximately 110 seconds.

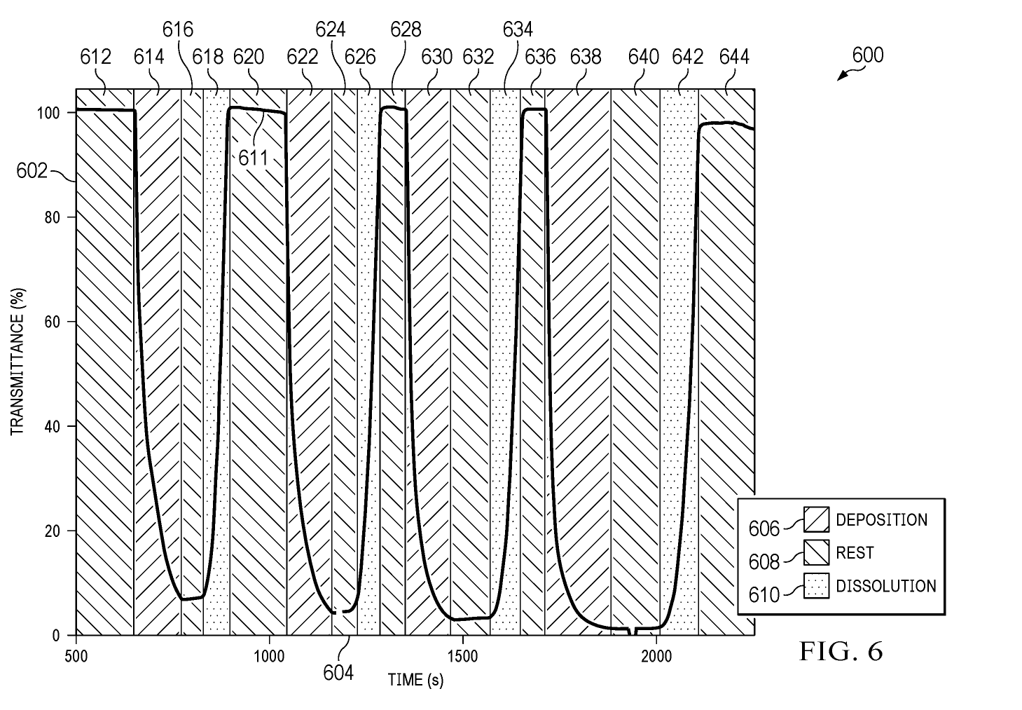

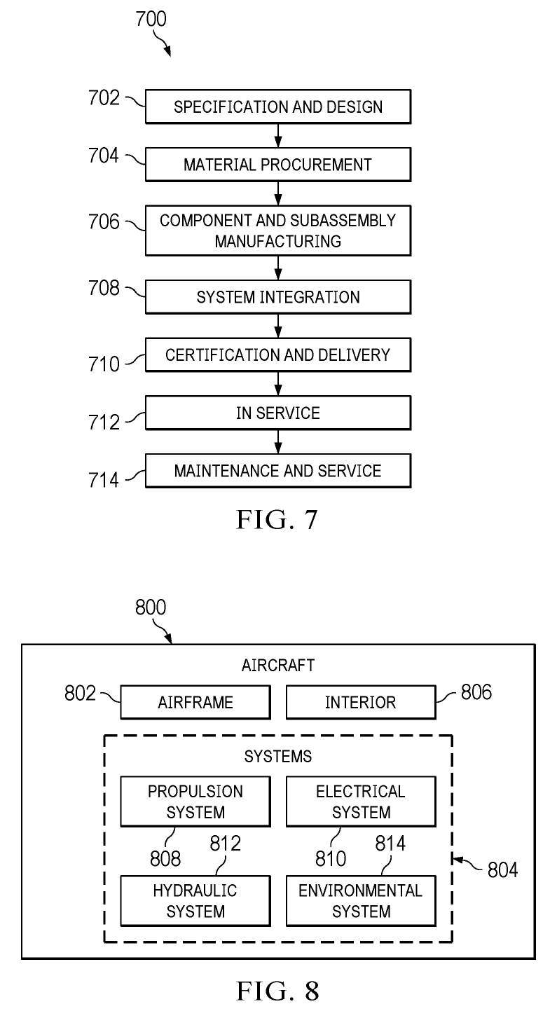

Illustrative embodiments of the present disclosure may be described in the context of aircraft manufacturing and service method 700 as shown in FIG. 6 and aircraft 800 as shown in FIG. 8. Turning first to FIG. 7, an illustration of an aircraft manufacturing and service method in a form of a block diagram is depicted in accordance with an illustrative embodiment. During pre-production, aircraft manufacturing and service method 700 may include specification and design 702 of aircraft 800 in FIG. 8 and material procurement 704.

During production, component and subassembly manufacturing 706 and system integration 708 of aircraft 800 takes place. Thereafter, aircraft 800 may go through certification and delivery 710 in order to be placed in service 712. While in service 712 by a customer, aircraft 800 is scheduled for routine maintenance and service 714, which may include modification, reconfiguration, refurbishment, or other maintenance and service.

Each of the processes of aircraft manufacturing and service method 700 may be performed or carried out by a system integrator, a third party, and/or an operator. In these examples, the operator may be a customer. For the purposes of this description, a system integrator may include, without limitation, any number of aircraft manufacturers and major-system subcontractors; a third party may include, without limitation, any number of vendors, subcontractors, and suppliers; and an operator may be an airline, a leasing company, a military entity, a service organization, and so on.

With reference now to FIG. 8, an illustration of an aircraft in a form of a block diagram is depicted in which an illustrative embodiment may be implemented. In this example, aircraft 800 is produced by aircraft manufacturing and service method 700 of FIG. 6 and may include airframe 802 with plurality of systems 804 and interior 806. Examples of systems 804 include one or more of propulsion system 808, electrical system 810, hydraulic system 812, and environmental system 814. Any number of other systems may be included.

Apparatuses and methods embodied herein may be employed during at least one of the stages of aircraft manufacturing and service method 700. One or more illustrative embodiments may be manufactured or used during at least one of component and subassembly manufacturing 706, system integration 708, in service 712, or maintenance and service 714 of FIG. 7.

As used herein, the phrase “at least one of,” when used with a list of items, means different combinations of one or more of the listed items may be used and only one of each item in the list may be needed. For example, “at least one of item A, item B, or item C” may include, without limitation, item A, item A and item B, or item B. This example also may include item A, item B, and item C or item B and item C. Of course, any combinations of these items may be present. In other examples, “at least one of” may be, for example, without limitation, two of item A; one of item B; and ten of item C; four of item B and seven of item C; or other suitable combinations. The item may be a particular object, thing, or a category. In other words, at least one of means any combination items and number of items may be used from the list but not all of the items in the list are required.

As used herein, “a number of,” when used with reference to items means one or more items.

The flowcharts and block diagrams in the different depicted embodiments illustrate the architecture, functionality, and operation of some possible implementations of apparatuses and methods in an illustrative embodiment. In this regard, each block in the flowcharts or block diagrams may represent at least one of a module, a segment, a function, or a portion of an operation or step.

In some alternative implementations of an illustrative embodiment, the function or functions noted in the blocks may occur out of the order noted in the figures. For example, in some cases, two blocks shown in succession may be executed substantially concurrently, or the blocks may sometimes be performed in the reverse order, depending upon the functionality involved. Also, other blocks may be added in addition to the illustrated blocks in a flowchart or block diagram. Some blocks may be optional.

The illustrative examples present reversible metal deposition devices. Using a non-aqueous electrolyte enables adjustable reflective windows with up to twenty times less heat absorbed, low and high temperature stability, and desirably rapid dynamic optical transmittance.

Adding a stripping additive in a non-aqueous electrochromic system, such as silver or zinc, aids in maintaining the desirably rapid dynamic optical transmittance. The stripping additive acid stops passivation of the metal layer and enables it to remain electrochemically active during cycling.

The illustrative examples present reversible metal deposition devices with an adjustable reflective treatment for airplane windows that reduces power, thermal constraints, and switching speed. The illustrative examples reversibly plate metal on a window to reflect out instead of absorbing unwanted light. The illustrative examples can reduce absorbed light up to twenty times.

The description of the different illustrative embodiments has been presented for purposes of illustration and description, and is not intended to be exhaustive or limited to the embodiments in the form disclosed. Many modifications and variations will be apparent to those of ordinary skill in the art. Further, different illustrative embodiments may provide different features as compared to other illustrative embodiments. The embodiment or embodiments selected are chosen and described in order to best explain the principles of the embodiments, the practical applications, and to enable others of ordinary skill in the art to understand the disclosure for various embodiments with various modifications as are suited to the particular use contemplated.

What is claimed is:

1. A reversible metal deposition device comprising:
a transparent conductive electrode;
a counter electrode;
an electrolyte between the transparent conductive electrode and the counter electrode, the electrolyte containing less than 5 atomic percent water;
a stripping additive in the electrolyte, the stripping additive comprising at least one of an acid or a base; and
metal salt in the electrolyte that supplies metal to be reversibly deposited onto the transparent conductive electrode.

2. The reversible metal deposition device of claim 1, wherein the metal salt comprises one of silver, copper, zinc, gold, cobalt, nickel, palladium, lead, bismuth, tin, aluminum, iron, gallium, indium, platinum, or tungsten.

3. The reversible metal deposition device of claim 1, wherein the metal salt comprises one of a chloride, a nitrate, a perchlorate, a sulfate, a sulfite, a fluoride, an iodide, or a bromide.

4. The reversible metal deposition device of claim 1, wherein the electrolyte comprises an organic material selected from one of DMSO, sulfolane, ethylene glycol, propylene carbonate, ethylene carbonate, or dimethyl formamide.

5. The reversible metal deposition device of claim 1, wherein the electrolyte comprises an ionic liquid.

6. The reversible metal deposition device of claim 1, wherein the electrolyte comprises less than 1 atomic percent water.

7. The reversible metal deposition device of claim 1, wherein the electrolyte comprises less than 100 parts per million water.

8. The reversible metal deposition device of claim 1, wherein the stripping additive comprises at least one of methane sulfonic acid, formic acid, glacial acetic acid, sulfuric acid, or perchloric acid.

9. The reversible metal deposition device of claim 1, wherein the stripping additive comprises at least one of ammonia or an amine.

10. The reversible metal deposition device of claim 1, wherein the transparent conductive electrode comprises one of an indium tin oxide electrode or a fluorine-doped tin oxide electrode on a substrate, wherein the substrate is a glass sheet or a polymer sheet.

11. The reversible metal deposition device of claim 1, wherein the transparent conductive electrode comprises a metal grid on a substrate, wherein the substrate is a glass sheet or a polymer sheet.

12. The reversible metal deposition device of claim 1, wherein the transparent conductive electrode comprises at least one of graphene or carbon nanotubes on a substrate, wherein the substrate is a glass sheet or a polymer sheet.

13. The reversible metal deposition device of claim 1 further comprising:
a wetting layer on the transparent conductive electrode.

14. The reversible metal deposition device of claim 1, wherein the reversible metal deposition device is a selectively darkening window, the selectively darkening window further comprising:
a reflective material on an outer surface of the selectively darkening window.

15. A reversible metal deposition device comprising:
a transparent conductive electrode comprising one of a glass sheet or a polymer sheet;
a counter electrode;
an electrolyte between the transparent conductive electrode and the counter electrode, the electrolyte containing less than 5 atomic percent water;
a stripping additive in the electrolyte, the stripping additive comprising an acid;
metal salt in the electrolyte that supplies metal to be reversibly deposited onto the transparent conductive electrode; and
a second substrate comprising a second glass sheet or a second polymer sheet.

16. The reversible metal deposition device of claim 15, wherein the metal salt comprises one of silver or copper.

17. The reversible metal deposition device of claim 15, wherein the stripping additive is methane sulfonic acid.

18. The reversible metal deposition device of claim 15, wherein the electrolyte comprises one of DMSO or propylene carbonate.

19. A reversible metal deposition device comprising:
a transparent conductive electrode;
a counter electrode;
an electrolyte in contact with the transparent conductive electrode, the electrolyte containing less than 5 atomic percent water;
metal salt in the electrolyte that supplies metal to be reversibly deposited onto the transparent conductive electrode, the metal salt comprising one of copper or silver; and
a stripping additive in the electrolyte, the stripping additive comprising at least one of an acid or a base configured to stop passivation of a metal layer formed on the transparent conductive electrode when the metal is deposited on the transparent conductive electrode.

20. The reversible metal deposition device of claim 19, wherein the stripping additive is methane sulfonic acid, and wherein the electrolyte comprises one of DMSO or propylene carbonate.
